(19) United States
(12) Patent Application Publication
(10) Pub. No.: US 2008/0135146 A1
(43) Pub. Date: Jun. 12, 2008

(54) SYSTEM AND METHOD FOR BALANCING A TIRE AND RIM ASSEMBLY

(76) Inventors: Michael Heffernan, Simcoe (CA); Russell J. Freeman, Vittoria (CA)

Correspondence Address: BERESKIN AND PARR, 40 KING STREET WEST, BOX 401, TORONTO, ON, M5H 3Y2, omitted

(21) Appl. No.: 11/928,946

(22) Filed: Oct. 30, 2007

Related U.S. Application Data
(60) Provisional application No. 60/863,494, filed on Oct. 30, 2006.

(51) Int. Cl. F16F 15/36; B23P 17/00

(52) U.S. Cl. 152/154.1; 29/894.31

(57) ABSTRACT

A self-balancing wheel assembly includes a rim, a tire mounted to the rim and defining an inflatable chamber between the rim and the tire, and a valve mounted to the rim for inflating and deflating the tire. The valve includes a housing having a channel therein extending between an outer surface of the housing and the chamber. The valve includes a stopper movable within the channel between an open and a closed position for allowing and blocking fluid flow through the channel, the stopper being narrower in width than the channel. The assembly further includes balancing media in the chamber, the balancing media comprising solid particles sized sufficiently large to inhibit passage of the solid particles past the stopper. The assembly can be used in wheels having integral TPMS modules, and having aluminum valve stems connected to the modules and short, nickel plated valve cores mounted in the stems.

This application claims the benefit of Provisional Application No. 60/863,494, filed Oct. 30, 2006, which is incorporated herein by reference.

### FIELD

The Applicants' teaching disclosed herein relates to tire balancing, and to methods and apparatuses for providing balanced wheel assemblies.

### BACKGROUND

U.S. Pat. No. 6,129,797 (Heffernan et al.) discloses a method and composition of matter for balancing tire and rim assemblies of vehicles wherein the composition of matter has rounded balancing elements of different size to line the interior of a tire casing and to move over the lining to offset points of imbalance.

U.S. Pat. No. 5,803,108 (Schuessler, Jr. et al.) discloses a method for inhibiting particulate material in a pneumatic tire from adversely affecting operation of a tire valve assembly. The method involves inserting a filter element into a valve stem passage of the wheel assembly, and then installing a sealing valve in the valve stem passage.

### SUMMARY

The following summary is intended to introduce the reader to the teaching disclosed herein but not to define any invention. One or more inventions may reside in a combination or sub-combination of the apparatus elements or method steps described below or in other parts of this document. The inventor does not waive or disclaim his rights to any invention or inventions disclosed in this specification merely by not describing such other invention or invention in the claims.

One aspect of the teaching described herein relates to a system for balancing a tire and rim assembly. The system comprises a tire and rim assembly having a hollow tire casing surrounding the space about the rim to define an interior space that is filled with a pressurized gas. The system further comprises a valve stem having a first open end accessible from outside of the tire and rim assembly, a second open end adjacent the interior space of the tire casing, and a bore extending between the first and second open ends. The system further comprises a valve core positioned within the bore for selectively permitting pressurized gas to enter and exit the interior space of the tire casing through the bore. The valve core has an outer surface, the valve stem has an inner surface, and an annular gap is formed between the valve core outer surface and the valve stem inner surface having a distance defined by D₁. The system further comprises balancing media located in the interior space of the tire casing. The solid particulate material is shaped and sized to be larger than D₁.

One or more other aspects relate to a method of assembling the system for balancing a tire and rim assembly described in the paragraph above. The method comprises the step of selecting balancing media comprising solid particulate material that is shaped and sized to be larger than D₁ so as to substantially prevent the solid particulate material from interfering with the operation of the valve core. The method further comprise the step of adding the balancing media selected in the previous step into the interior space of the tire casing.

One or more other aspects relate to a method of balancing a tire and rim assembly during rotation. The method comprise the step of providing a tire and rim assembly having a hollow tire casing surrounding a space about the rim and having a point of imbalance when the space is filled with a pressurized gas. The method further comprise the step of providing a valve stem having a first open end accessible from outside of the tire and rim assembly, a second open end adjacent the interior space of the tire casing, and a bore extending between the first and second open ends. The method further comprise the step of providing a valve core positioned within the bore for selectively permitting pressurized gas to enter and exit the interior space of the tire casing through the bore. The valve core having an outer surface, the valve stem having an inner surface and an annular gap being formed between the valve core outer surface and the valve stem inner surface having a distance defined by D₁. The method further comprising the step of selecting balancing media comprising solid particulate material that is shaped and sized to be larger than D₁. The method further comprising the step of adding the balancing media into the interior of the tire casing before or during pressurization with gas. The method further comprising the step of rotating the tire rim and assembly to distribute the balancing media within the tire casing to offset the point of imbalance.

Additional features, advantages, and embodiments of one or more of applicants' teachings may be set forth or apparent from consideration of the following detailed description, drawings and claims. Moreover, it is to be understood that both the foregoing introduction and the following description provide examples or further explanation without limiting the scope of applicants' teachings as claimed.

### BRIEF DESCRIPTION OF THE DRAWINGS

The skilled person in the art will understand that the drawings, described below, are for illustration purposes only. The drawings are not intended to limit the scope of the applicants' teachings in any way. In the drawings:

FIG. 1 illustrates a perspective cross-sectional view of a tire and rim assembly while the tire and rim assembly is stationary;

FIG. 2 illustrates a cross-sectional view of a tire and rim assembly taken along line 2-2 of FIG. 1 while the tire and rim assembly is stationary;

FIG. 3 illustrates a side sectional view of a tire and rim assembly taken along line 3-3 of FIG. 1 while the tire and rim assembly is rotating;

FIG. 4a illustrates a partial cross-sectional view of a tire pressure monitoring unit connected to a valve assembly which is in a closed position;

FIG. 4b illustrates a partial cross-sectional view of a tire pressure monitoring unit connected with a valve assembly which is in an open position; and

FIG. 5 is an enlarged view of a portion of the system of FIG. 4b.

### DETAILED DESCRIPTION

Various apparatuses or methods will be described below to provide an example of an embodiment of each claimed invention. No embodiment described below limits any claimed invention and any claimed invention may cover apparatuses or methods that are not described below. The claimed inventions are not limited to apparatuses or methods having all of the features of any one apparatus or method described below or to features common to multiple or all of the apparatuses described below. It is possible that an apparatus or process described below is not an embodiment of any claimed invention. The applicants, inventors or owners reserve all rights that they may have in any invention disclosed in an apparatus or method described below that is not claimed in this document, for example the right to claim such an invention in a continuing application and do not intend to abandon, disclaim or dedicate to the public any such invention by its disclosure in this document.

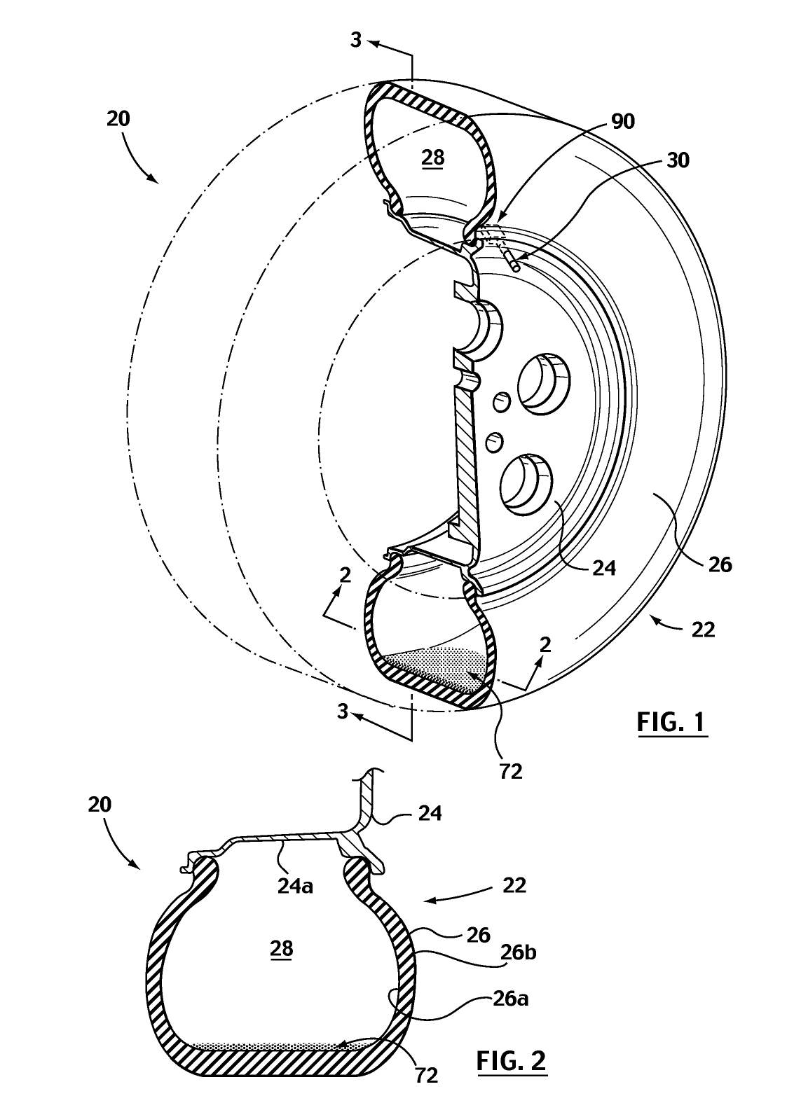

A balancing system 20 according to one example of the applicant's teaching is shown generally in FIG. 1. In the example illustrated, the balancing system 20 is shown in use for balancing a wheel assembly 22. The wheel assembly 22 (also referred to herein as a tire and rim assembly) includes a rim 24 mountable to a vehicle (not shown), and a pneumatic tire 26 mounted to the rim 24. A generally enclosed chamber 28 for holding air (or another gas) is provided between a radially outer surface 24a of the rim 24 and an inner surface 26a of the tire 26. The tire 26 has an outer surface 26b, opposite the inner surface 26a.

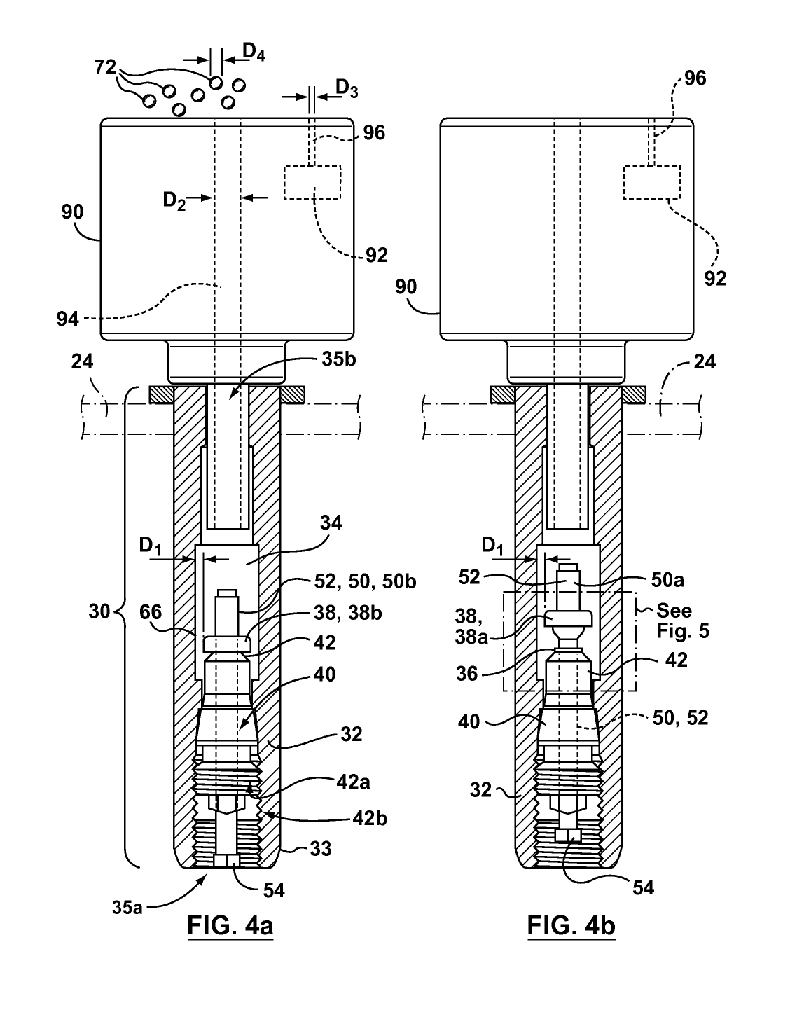

The wheel assembly 22 further includes a valve 30 mounted to the rim 24 for inflating and deflating the tire 26. The valve 30 comprises a valve housing 32 having an outer surface 33 extending generally inwardly from the rim 24, opposite the tire 26 (FIGS. 4a and 4b). The valve 30 has a duct 34 extending through the valve housing 32, providing a fluid path from the outer surface 33 of the housing 32 to the chamber 28 of the wheel assembly 22, via an aperture in the rim 24. In the example illustrated, the valve housing 32 is generally cylindrical in shape, and the duct 34 comprises an axial bore extending through the housing 32 and open at either end thereof (i.e. at an outer end 35a that is distal the rim 24, and an inner end 35b proximate the rim 24). The valve housing 32 of the example illustrated is also referred to as a valve stem. The valve housing 32 can be made of a suitable metal, and in the example illustrated is of aluminum material, which can facilitate use of the valve housing 32 in combination with a Tire Pressure Monitoring System.

The valve 30 further comprises a valve seat 36 and a stopper 38 disposed in the duct 34. The stopper 38 is, in the example illustrated, axially movable relative to the valve seat 36 between open and closed positions 38a, 38b. In the closed position 38b (FIG. 4a), the stopper 38 engages the valve seat 36 to block fluid flow through the duct 34. In the open position 38a (FIG. 4b), the stopper 38 is disengaged from the valve seat 36 to allow fluid flow through the duct 34.

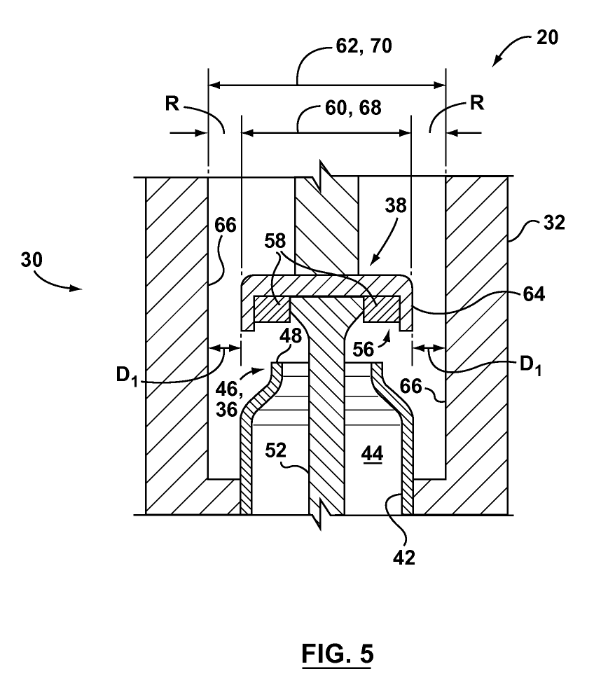

Referring also to FIG. 5, in the example illustrated, the valve seat 36 and stopper 38 comprise a valve core 40 that is positioned in the duct 34. The valve core 40 comprises a sleeve 42 that is axially fixed within the duct 34 by, in the example illustrated, screwing an externally threaded portion 42a of the sleeve 42 into an internally threaded 42b portion of the duct 34. The sleeve 42 is hollow, and the hollow interior forms a channel 44 (FIG. 5) through which fluid flowing through the duct 34 can pass when the valve 30 is in the open position 38a. An inner end 46 of the sleeve 42 (proximate the rim 24) is provided with the valve seat 36, in the form of an annular edge face 48 directed towards the rim 24. The sleeve 42 can be made of a suitable material such as metal, and in the example illustrated is of a nickel plated brass construction. The nickel plating can provide a satisfactory joint with the aluminum valve housing 32 of the example illustrated.

In the example illustrated, a plunger 50 is retained in the sleeve 42. The plunger 50 comprises a shaft 52 and is axially displaceable within the sleeve 42, between an advanced position 50a (displaced towards the rim) and a retracted position 50b (displaced away from the rim 24). The advanced and retracted positions 50a, 50b correspond to the open and closed positions 38a, 38b, respectively, of the valve 30. The plunger 50 is biased towards the retracted (closed) position 50b by, for example, a spring (not shown) retained in the sleeve 42.

The valve 30 comprises an actuator 54, which in the example illustrated comprises a pin joined to the shaft 52 of the plunger 50. The actuator 54 is accessible from the open outer end 35a of the duct 34, and can be depressed to urge the valve 30 from the closed position 38b to the open position 38a.

The stopper 38 is, in the example illustrated, fixed to the shaft 52 of the plunger 50 (opposite the actuator 54), and comprises an annular pocket 56 with an o-ring 58 retained therein, positioned adjacent the annular edge face 48 of the seal seat 36. In the example illustrated, the stopper 38 has a lateral extent 60 (the lateral direction being generally transverse to the direction of fluid flow through the duct in which it is positioned) that is less than the lateral extent 62 of the duct 34. The stopper 38 has a laterally distal surface 64 that is nearest the wall (or inner surface) 66 of the duct 34, and a lateral gap D₁ is provided between the distal surface 64 of the stopper 38 and the inner surface 66 of the duct 34. The lateral gap D₁ acts as a passageway through which air (or another gas) can flow when the valve 30 is in the open position 38a.

In the example illustrated, the distal surface 64 of the stopper 38 is generally circular in cross section, and is coaxial with the cylindrical duct 34 in which it is positioned. The transverse gap D₁ is generally equal at any point along the perimeter of the laterally distal surface 64 of the stopper 38. In other words, an annular space is generally provided between a minor diameter 68 defined by the outer surface 64 of the stopper 38 and a major diameter 70 defined by the inner surface 66 of the duct 34, and the radial difference R between the minor and major diameters 68, 70 of the annular space is generally equal to the size of the transverse gap D₁. In the example illustrated, the transverse gap D₁ (i.e. half the difference between the diameter of the channel and the diameter of the outer surface of the stopper) is about 0.85 mm. The tolerance on this dimension is about +/−0.32 mm. Thus the transverse gap D₁ will generally vary (across a large sample size of the valves of the present example) between a minimum of about 0.53 mm and a maximum of about 1.17 mm.

Referring now to FIGS. 1-3, the balancing system 20 includes balancing media 72 that, in the example illustrated, comprises solid particulate that is free to shift within the chamber 28. When the wheel 22 is in motion, the particulate 72 generally shifts inside the wheel to automatically offset any imbalance in the wheel.

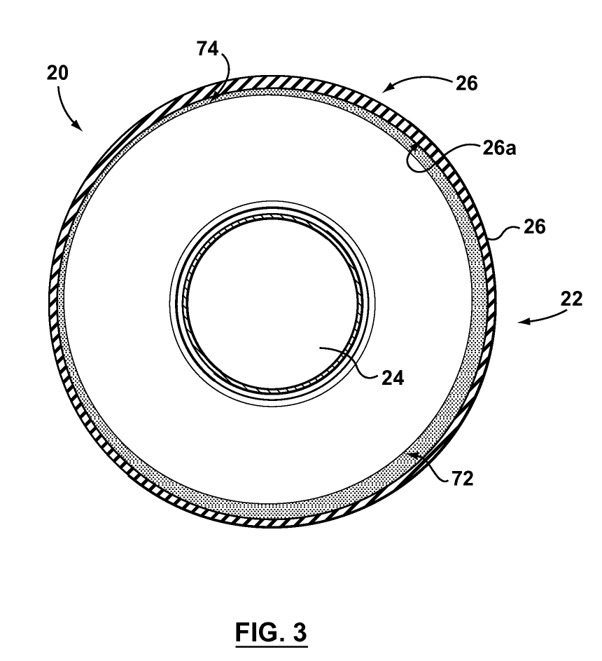

As shown in FIG. 3, the solid particulate material 72 lines the interior surface of the tire casing 26 while the tire and rim assembly 22 is in rotation by reason of the centrifugal force exerted on the solid particulate material 72. The solid particulate material 72 distributes within the tire 26 so that a thicker layer of the solid particulate 72 lies opposite a point of imbalance that is shown generally at 74. Effectively, the distribution of the solid particulate material 72 acts as a mass damping to overcome the eccentric force that would otherwise be introduced by the point of imbalance 72.

According to the applicant's teaching, the solid particles 72 of the balancing media are sized sufficiently large so that they cannot work their way past the stopper 38 in the duct 34. Such sizing of the particles 72 can inhibit or prevent the solid particulate material 72 from interfering with the operation of the valve 30, which could result, for example, if the particulate 72 could become lodged behind the stopper 38.

In the example illustrated, the solid particulate material 72 is substantially rounded or spherical in shape so as to reduce friction and improve the mobility and redistribution of the particles 72 within the chamber 28 during the balancing process. The solid particulate material 72 has, in the example illustrated, an average diameter D₄ that can be within the range of between about 1.0 mm to about 4.0 mm, or in the range of between about 1.2 mm to about 3.0 mm.

The solid particulate material 72 may be formed from glass, ceramics, alumina, corderite, porcelain, titanates, or any combinations thereof. The solid particulate material may have a density in the range of between about 2 gr/cm³ to about 5 gr/cm³, or in the range of between about 2 gr/cm³ to about 3 gr/cm³.

The outer surfaces of the solid particulate material 72 may be coated with a partitioning agent or lubricant to reduce the friction between the solid particulate material 72 and the interior surface of the tire casing. Examples of such partitioning agents or lubricants include, but are not limited to, polytetrafluorethylene (PTFE), perfluorocarbon resins (PFC), organo silicones, and silanes. The partitioning agents or lubricants may be sprayed or otherwise applied to the outer surfaces of the solid particulate material 72.

The outer surfaces of the solid particulate material 72 may also be coated with an anti-static agent to reduce the ‘electrostatic cling’ or ‘attraction’ between the solid particulate material and the interior surface of the tire casing 30. Examples of such anti-static agents include, but are not limited to, ethoxylated amine, glycerol monostearate, and lauric diethanolamide. The anti-static agents can be sprayed or otherwise applied to the outer surfaces of the solid particulate material.

The outer surfaces of the solid particulate material may also be coated with a sealant. An example of such a sealant includes, but is not limited to, silicone-based sealants.

The Applicants' teaching disclosed herein can provide a self-balancing wheel for use with most or all vehicles. The amount of balancing media 72 provided to balance a particular tire and rim assembly can be customized to suit the size of the wheel to be balanced. For example purposes only, a steering tire of a truck (11×24.5) may be provided with about 400 grams of balancing media, a truck driving tire may be provided with about 500 grams of the balancing media, an automobile tire may be provided with 100 grams of the balancing media.

Examples of balancing systems 20 in accordance with the applicant's teaching disclosed herein can provide a self-balancing wheel using conventional valve cores without filtering elements associated therewith. As well, the balancing systems can be used with short valve cores having enclosed springs, or with long valve cores having exposed springs.

Furthermore, the balancing system 20 can be used with wheels having nickel plated short valve cores, as are commonly used, for example, in wheel assemblies having integral TPMS (Tire Pressure Monitoring System) components. In the example illustrated, the wheel assembly 22 includes a pressure sensing and transmitting module 90 secured within the chamber, adjacent the valve 30. The module 90 includes a sensor 92 in fluid communication with the gas (i.e. air) in the chamber 28. Gas can flow between the valve 30 and chamber 28 through a conduit 94 provided in the module 90, the conduit 94 providing part of or an extension to the duct 34. The conduit 94 can have a diameter D₂ greater than the transverse extent of the D₁ particles 72. Alternatively or additionally, gas can flow through spaces provided in the joint between the module and inner end of the valve (i.e. at the rim) to provide fluid communication between the outer end 35a of the valve 30 and the chamber 28.

A pick-up tube 96 (or input tube 96) can extend from an outer surface of the module to the sensor 92. The tube 96 can have a diameter D₃ equal to or less than the lateral gap D₁, so that particulate 72 sized greater than D₁ will also be prevented from fouling the input tube 96.

In some examples, the stopper 38 may be able to shift laterally within the duct 34. This could be caused, for example, by lateral flexing or displacement of the shaft within the sleeve 42, particularly when the valve 30 is in the open position 38a. Under such circumstances, the lateral gap D₁ can increase, and so a larger sized particle may be desirable. In the example illustrated, the maximum deflection would generally result in a maximum lateral gap D₁ of twice the R dimension (i.e. twice the original D₁), or about 2.34 mm. The particles 72 can be sized to have a transverse extent or minimum diameter D₄ of about 2.4 mm. The particles 72 can be sized to be in the range of about 2.5 mm to about 3.0 mm.

A method of assembling a system 20 for balancing a tire and rim assembly 22 having an integral TPMS module 90 is also disclosed. The method comprise the step of selecting balancing media comprising solid particulate material 72 that is shaped and sized to be larger than the diameter D3 of the input tube 96 of the TPMS module 90 so as to substantially prevent the solid particulate material 72 from interfering with the operation of the sensor 92. The method additionally comprises the step of adding the balancing media 72 selected in the previous step into the chamber 28 of the tire 26.

The balancing media 28 may be provided into the chamber 28 of the tire 26 through the valve housing (stem) 32 with the valve core 40 removed from the housing 32 (i.e. prior to pressurization of the wheel assembly 22). Alternatively, the balancing media 72 may be added into the chamber 28 during the assembly of the tire and rim assembly 22. For example, the balancing media 72 may be poured into a tire 26 as it is assembled onto a rim 24. Another example includes breaking the sealing bead (not shown) on a tire and rim assembly 22 and pouring the balancing media 72 into the tire 26.

A valve 30 may be installed on the wheel 22, the valve 30 having an aluminum housing 32. The housing 32 can be in electrical communication with the sensor 92, and can be used as an antenna for transmitting signals from the module 90 to a receiver mounted in the vehicle. The receiver (not shown) can present a signal to the driver of the vehicle to indicate whether or not the tire is satisfactorily inflated.

While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

We claim:

1. A self-balancing wheel assembly, comprising:
a) a rim;
b) a tire mounted to the rim and defining an inflatable chamber between the rim and the tire;
c) a valve mounted to the rim for inflating and deflating the tire, the valve including a housing having a channel therein extending between an outer surface of the housing and the chamber, the valve including a stopper movable within the channel between an open and a closed position for allowing and blocking fluid flow through the channel, the stopper being narrower in width than the channel; and
d) balancing media in the chamber, the balancing media comprising solid particles sized sufficiently large to inhibit passage of the solid particles past the stopper in the channel.

2. The assembly of claim 1, wherein the stopper comprises a laterally distal surface spaced apart from an inner surface of the channel by a transverse gap.

3. The assembly of claim 2 wherein the solid particles are generally sized to each have a transverse extent greater than that of the transverse gap.

4. The assembly of claim 2, wherein the solid particles are generally spherical in shape.

5. The assembly of claim 4, wherein the solid particles have a diameter in a range from about 1.2 mm to about 3.0 mm.

6. The assembly of claim 1, wherein the solid particles comprise material selected from the group consisting of glass, ceramics, alumina, corderite, porcelain, titanates, and mixtures thereof.

7. The assembly of claim 6, wherein the solid particles have a density of between about 2 gr/cm³ to about 5 gr/cm³.

8. The assembly of claim 1, wherein the solid particles have outer surfaces comprising a coating that acts as a partitioning agent to reduce friction between the solid particulate material and an interior surface of the tire casing.

9. The assembly of claim 1, wherein the solid particles have outer surfaces comprising a coating that acts as an anti-static agent to reduce the electrostatic cling between the solid particulate material and the interior surface of the tire casing.

10. The assembly of claim 2, further comprising a tire pressure monitoring unit having a pressure sensor and a body defining an input tube, the input tube providing fluid communication between the pressure sensor and the interior space of the tire casing, the input tube having a diameter that is less than or equal to the transverse gap.

11. A system for balancing a tire and rim, the system comprising:
a) a tire and rim assembly having a hollow tire casing surrounding the space about the rim to define an interior space that is filled with a pressurized gas;
b) a valve stem having a first open end accessible from outside of the tire and rim assembly, a second open end adjacent the interior space of the tire casing, and a bore extending between the first and second open ends;
c) a valve core positioned within the bore for selectively permitting pressurized gas to enter and exit the interior space of the tire casing through the bore; and
d) balancing media located in the interior space of the tire casing, the balancing media comprising solid particulate material,
and wherein the valve core has an outer surface, the valve stem has an inner surface, an annular gap is formed between the valve core outer surface and the valve stem inner surface having a distance defined by D₁, and the solid particulate material is shaped and sized to be larger than D₁.

12. A system according to claim 11, wherein the solid particulate material is shaped and sized to be larger than 2×D₁.

13. A method of balancing a tire and rim assembly during rotation, the tire and rim assembly having a tire pressure monitoring unit, the method comprising:
a) mounting a tire onto a rim to define an inflatable rim assembly having a hollow tire chamber therebetween;
b) mounting a valve to the rim to facilitate inflating and deflating the tire, the valve including a housing having a channel therein extending between an outer surface of the housing and the chamber, the valve including a stopper movable within the channel between an open and a closed position for allowing and blocking fluid flow through the channel, respectively, the stopper being narrower in width than the channel, and the stopper having a laterally distal surface spaced apart from an inner surface of the channel by a transverse gap;
c) adding balancing media into the chamber, the balancing media comprising solid particles having a transverse extent greater in size than the transverse gap;
d) injecting gas into the inflatable chamber to inflate the tire, the inflated tire and rim defining a wheel assembly having a point of rotational imbalance; and
e) rotating the wheel assembly to distribute the balancing media within the chamber to offset the point of imbalance.

14. A method according to claim 13, wherein the solid particles added in step (c) have a transverse extent at least twice as large as the transverse gap.

15. The method of claim 13 further comprising providing a tire pressure monitoring unit having a body with a pressure sensor housed therein, and an input tube extending through the body between the sensor and the chamber, the input tube having a diameter defined by D₂, and wherein the solid particles added in step (c) have a transverse extent larger than D₂.

16. The method of claim 13, wherein step (c) comprises using generally spherical particulate matter as the solid particles of the balancing media.

17. The method of claim 16 wherein step (c) comprises using solid particulate material that has a transverse extent from about 1.2 mm to about 3.0 mm as the solid particles of the balancing media.

18. A method according to claim 16, additionally comprising, before step (c), the step of selecting the solid particulate material from the group consisting of glass, ceramics, alumina, corderite, porcelain, titanates, and mixtures thereof.

19. A method according to claim 16, additionally comprising, before step (c), the step of selecting solid particulate material that is glass.

20. A method according to claim 16, additionally comprising, before step (c), the step of selecting solid particulate material that has a density of between about 2 gr/cm³ to about 5 gr/cm³.
